(19) United States
(12) Patent Application Publication
(10) Pub. No.: US 2018/0240356 A1
(43) Pub. Date: Aug. 23, 2018

(54) DATA-DRIVEN FEEDBACK GENERATOR FOR PROGRAMMING ASSIGNMENTS

(71) Applicant: Microsoft Technology Licensing, LLC, Redmond, WA (US)

(72) Inventors: Rishabh Singh, Kirkland, WA (US); Paul F. Pardi, Edgewood, WA (US); Benjamin L. Lin, Palo Alto, CA (US); Bjorn C. Rettig, Redmond, WA (US); Ke Wang, Davis, CA (US)

(73) Assignee: Microsoft Technology Licensing, LLC, Redmond, WA (US)

(21) Appl. No.: 15/594,050

(22) Filed: May 12, 2017

Related U.S. Application Data
(60) Provisional application No. 62/461,619, filed on Feb. 21, 2017.

(51) Int. Cl. G09B 19/00; G06F 11/36; G06F 9/45; G09B 5/02

(52) U.S. Cl. CPC G09B 19/0053; G09B 5/02; G06F 8/42; G06F 11/3688

(57) ABSTRACT

Described herein is a system and method for automatically evaluating and providing feedback on code submissions. For example, when a code submission is received, the system described herein is configured to find closely related operable code submissions and compute corresponding expression discrepancies between the submitted code and operable and well-styled code submissions. The system then computes a minimal set of possible changes from the discrepancies to correct or improve the code submission. The changes can then be displayed and/or otherwise provided to the user or student who submitted the original code.

### CROSS-REFERENCE TO RELATED APPLICATION

This application claims priority to U.S. Provisional Application No. 62/461,619, entitled “Data-Driven Feedback Generator for Programming Assignments,” filed on Feb. 21, 2017 the entire disclosure of which is hereby incorporated by reference in its entirety.

### BACKGROUND

Manually providing feedback for a programming assignment is a tedious task in traditional classroom education. Typically, if a code submission does not execute correctly, a student must submit his/her code for review. Once the code is received, a professor, a teacher, a student assistant, etc. has to review the various lines of code to determine where the bugs exist and provide suggestions of how to fix the errors so the program runs properly. However, every programming assignment may be coded in a number of different ways. Therefore, it may be difficult to track down the errors in each code submission.

The challenges set forth above increase drastically in online courses. In some cases, the student-teacher ratio can reach thousands of students to one professor. Given these ratios, it is nearly impossible for a single individual, or even multiple individuals, to provide effective feedback on code for various programming assignments.

It is with respect to these and other general considerations that examples have been described. Also, although relatively specific problems have been discussed, it should be understood that the examples should not be limited to solving the specific problems identified in the background.

### SUMMARY

This disclosure generally relates to a system and method for providing automatic code review and feedback for programming assignments. More specifically, the examples described herein are directed to a data-driven approach for automatically generating feedback and/or suggested code corrections for programming assignments. As will be explained below, when a programming assignment for a programming course is submitted, a vast majority of the incorrect code submissions (e.g., programming code submissions that do not fully and/or accurately complete the assigned programming task) will have correct counterparts (e.g., programming code submissions that fully and/or accurately complete the assigned programming task) that can be used for correcting the incorrect code submissions.

For example, when an incorrect code submission is received, the system is configured to find a closely related correct code submission (both syntactically and semantically) to compute corresponding expression discrepancies. The system then computes a minimal set of repairs from the discrepancies that are used to correct the incorrect code submission. The repairs can then be provided to the individual who wrote and submitted the incorrect code submission. This approach requires no teacher data curation, and the system learns to fix incorrect code submissions from correct code submissions.

Accordingly, described herein is a system comprising a processing unit and a memory storing computer executable instructions which, when executed by the processing unit, causes the system to perform a method for providing automatic feedback for code submissions. This method includes receiving a plurality of code submissions and testing each of the plurality of code submissions using one or more test cases. The test cases are used to identify which code submissions of the plurality of code submissions are correct and which code submissions are incorrect. That is, a determination may be made as to whether the code submissions correctly or incorrectly execute the one or more test cases. A correct control flow representation is then generated for each code submission that correctly executes the one or more test cases and an incorrect control flow representation is generated for each code submission that incorrectly executes the one or more test cases. Each of the incorrect control flow representations is compared to one or more of the correct control flow representations to determine one or more corrections that need to be made to a corresponding code submission that incorrectly executed the one or more test cases.

Also described is a method for automatically correcting incorrect code submissions. This method includes generating an incorrect control flow representation of an incorrect code submission and comparing the incorrect control flow representation to a cluster of correct control flow representations. Each correct control flow representation in the cluster is associated with a set of correct code submissions. One or more correct control flow representations that correspond to the incorrect control flow representation is/are then identified. The incorrect code submission is compared with a set of closest correct code submissions associated with each of the identified one or more correct control flow representations. By comparing the incorrect code submissions with close correct code submissions, a set of potential expression changes are collected. These expression changes are then tried out in an enumerative fashion to compute the minimal set of changes to the incorrect code submission such that it now passes the one or more test cases. The corrections are then caused to be displayed and/or otherwise provided to an individual who submitted the incorrect code submission.

Also described is a computer-readable storage medium storing computer executable instructions that, when executed by a processing unit, cause the processing unit to perform a method for automatically correcting incorrect code submissions. This method includes receiving a code submission and testing the code submission using one or more test cases to determine whether the code submission is an incorrect code submission. When it is determined that the code submission is an incorrect code submission, an incorrect control flow representation of the incorrect code submission is generated. The incorrect control flow representation is compared to a cluster of correct control flow representations. Each correct control flow representation in the cluster is associated with a set of correct code submissions. One or more correct control flow representations that correspond to the incorrect control flow representation is/are then identified and the incorrect code submission is compared with the correct code submissions associated with each of the identified one or more correct control flow representations. One or more corrections to the incorrect code submission are then generated and are based on the comparison between the incorrect code submission and the correct code submission. The one or more corrections are then provided to an individual that submitted the incorrect code submission.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a system for automatically correcting code submissions according to an example embodiment.

FIG. 2A illustrates example code segments that may be received by the system shown in FIG. 1.

FIG. 2B illustrates how the code segments in FIG. 2A are represented in a control flow representation according to an example embodiment.

FIG. 3A illustrates how variables from different code segments may be mapped to one another according to an example embodiment.

FIG. 3B illustrates how the variables within the code segments may be represented by the characters of their respective control flow representations according to an example embodiment.

FIG. 3C shows an example of how variables in one code segment may be replaced with variables in another code segment according to an example embodiment.

FIG. 3D shows another example of how variables in one code segment may be replaced with variables in another code segment according to an example embodiment.

FIG. 4A illustrates example abstract syntax trees that may be generated from different code submissions according to an example embodiment.

FIG. 4B shows how nodes in the abstract syntax trees of FIG. 4A are traversed in a compare operation according to an example embodiment.

FIG. 4C shows the progression of the node comparison in the abstract syntax trees of FIG. 4A.

FIG. 4D also shows the progression of the node comparison in the abstract syntax trees of FIG. 4A.

FIG. 4E also shows the progression of the node comparison in the abstract syntax trees of FIG. 4A.

FIG. 5A illustrates how different variables in abstract syntax trees may be replaced with one another in order to correct an incorrect code submission according to an example embodiment.

FIG. 5B also illustrates how different variables in the abstract syntax trees of FIG. 5A may be replaced with one another in order to correct the incorrect code submission according to an example embodiment.

FIG. 5C illustrates how the variable replacement can be minimized according to an example embodiment.

FIG. 5D also illustrates how the variable replacement can be minimized according to an example embodiment.

FIG. 6 illustrates a method for automatically providing feedback for a code submission according to an example embodiment.

FIG. 7 is a block diagram illustrating example physical components of a computing device with which aspects of the disclosure may be practiced.

FIGS. 8A and 8B are simplified block diagrams of a mobile computing device with which aspects of the present disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

This disclosure describes a code correction system that automatically corrects and provides feedback for programming code that is submitted in response to a programming assignment. As described above, manually providing feedback for a programming assignment is a tedious task. This task becomes more difficult in online courses in which the student-teacher ratio can reach thousands of students to one professor. Further, there are numerous ways in which the code for a particular programming assignment may be written while still achieving the same results.

Accordingly, the code correction system described herein receives code submissions from various individuals. Once received, each of the code submissions executes various predefined test cases to determine whether the code submission is operable or inoperable. For example, the code submissions execute one or more test cases to determine whether the code submissions accurately perform the tasks set forth in a programming assignment.

The code submissions that are operable (e.g., fully execute and/or correctly execute the test cases) are referred to herein as correct code submissions. Thus, as used herein, the term correct (e.g., correct code submission, correct control flow representation, and so on) is used to mean that the code submission fulfils the requirements of the programming project. However, even correct code submissions can receive feedback using the system and method described herein. For example, the system may provide feedback about stylistic changes, efficiency changes and so on.

Once it is determined that a code submission is a correct code submission, it is stored in a database along with other operable submissions. These correct code submissions are used as references for the code submissions that are inoperable or do not fully execute the test cases or execute the test cases incorrectly (referred to herein as incorrect code submissions). The incorrect code submissions may then be compared against the correct code submissions. Suggested changes to the incorrect code submissions may then be displayed and/or otherwise provided to the individual who submitted the incorrect code submissions.

However, a programming assignment may be coded in a number of different ways. For example, one individual may use a first collection of variables, conditions, method calls and so on, while a second individual may use a completely different collection of variables, conditions and method calls. Further, various methods, functions, and calculations for each code submission may be performed in different orders and/or at different times. Thus, it becomes difficult to compare the incorrect code submission with the correct code submission and provide meaningful feedback and/or corrections.

Accordingly, the code correction system is configured to generate a control flow representation for each code submission. A control flow is an order in which statements, instructions, method calls, function calls and the like of a program are executed. Accordingly, each code submission can be distilled into a particular control flow representation. In the description that follows, a control flow representation that is generated for a correct code submission is referred to as a correct control flow representation and a control flow representation that is generated for an incorrect code submission is referred to as an incorrect control flow representation.

Once the control flow representation for the various code submissions have been generated, an incorrect control flow representation is compared against various correct control flow representations to determine the extent to which they match. That is, a control flow of an incorrect code submission can be matched with a control flow of a correct code submission even though the incorrect code submission may include different variables, methods and functions than the correct code submission. In some examples, the matching determination requires that the incorrect control flow representation is an exact match with a correct control flow representation. In other examples, the matching determination may require that the control flows meet a similarity threshold (e.g., the incorrect control flow representation is 90% similar to the correct control flow representation). As used herein, unless otherwise stated, “matching” refers to both exact matching and matching meeting a similarity threshold.

Once the incorrect control flow representation has been matched with a correct control flow representation, the code correction system creates an abstract syntax tree of the incorrect code submission that is associated with the incorrect control flow representation and makes a node by node comparison of an abstract syntax tree that was generated for the correct code submission that is associated with the matching correct control flow representation.

The abstract syntax tree that was created from the incorrect code submission may be compared against any number of abstract syntax trees that were generated from correct code submissions. However, in some examples, the comparison between abstract syntax trees occurs only when the incorrect code submission and the correct code submissions have matching control flow representations.

Once the node by node comparison between the abstract syntax trees has been completed, a determination is made as to which correct code submission is closest to the incorrect code submission. That is, a determination is made as to how the incorrect code submission can be changed to match the correct code submission to which it is most similar. The determined changes may then be displayed and/or otherwise provided to the individual who submitted the incorrect code submission.

In some implementations, the code correction system is configured to select the fewest number of changes to the incorrect code submission when providing feedback to the individual. For example, the code correction system is configured to test each of the possible changes between the incorrect code submission and the correct code submission, and make the minimum number of suggested changes that causes the incorrect code submission to execute the test cases properly.

In yet other examples, the system described herein may be used to compare operable or correct code submissions against other operable or correct code submissions and provide feedback and/or changes that can make the correct code submissions more efficient. For example, the system may be configured to determine how efficiently each correct code submission executes the various test cases. The correct code submission may be associated with an efficiency score and when a correct code submission with a lower efficiency score is received, the system can compare the control flow representation of the correct code submission with other correct control flow representations, find code submissions with a higher efficiency score and provide feedback and/or comments in the same manner as described with respect to incorrect code submissions.

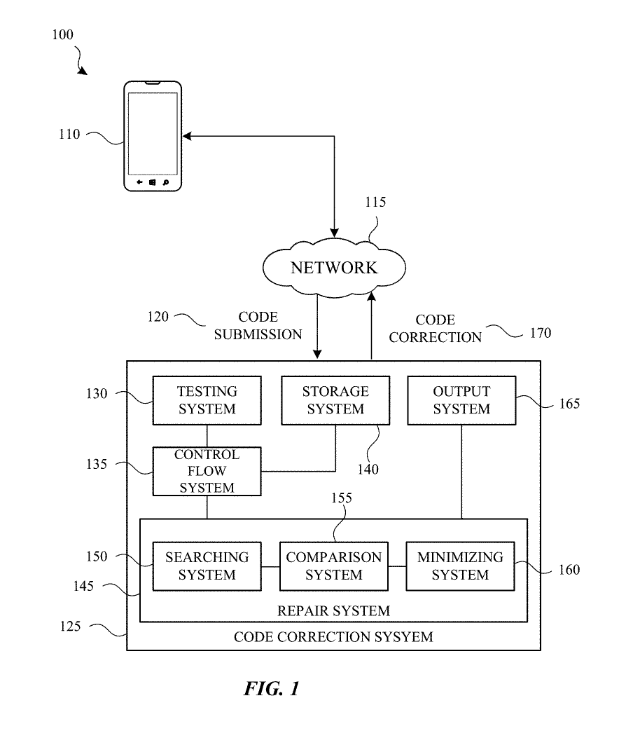

These and other examples will be described in more detail below with respect to FIGS. 1-6.

FIG. 1 illustrates an example system 100 for automatically correcting and/or providing feedback for a code submission 120. The code submission 120 may be provided to the system 100 as part of a programming assignment. For example, an individual may be enrolled in a programming class (e.g., C#, C++, JAVA, etc.) at a university, a college, a high school, an online course and so on, and may be asked to write various programs or complete various programming assignments for the programming class. As the individual completes the assigned programs, the individual may submit his/her code (e.g., a code submission 120) to the system 100.

In some instances, an individual may write or otherwise access code on a computing device 110. The code may be written by the individual in response to a programming assignment such as described above.

The computing device 110 may be any computing device capable of connecting to a network 115. Example computing devices include, but are not limited to, a mobile telephone, a smart phone, a tablet, a phablet, a smart watch, a wearable computer, a personal computer, a desktop computer, a laptop computer, a gaming device/computer (e.g., Xbox®), and the like.

Once the program is complete, the computing device 110 transmits the code (shown in FIG. 1 as code submission 120), over the network 115, to a code correction system 125. Once the code submission 120 has been received, a testing system 130 executes the code submission 120 to determine whether the programming assignment was completed correctly or incorrectly.

Once the code submission 120 is received, the system 100 executes the code submissions 120 against one or more test cases to determine if the program runs correctly. If the program does not correctly execute the test cases, the system provides feedback (in some cases, in the form of corrections that can be made to the code submission) to the individual who provided the code submission. For example, the system 125 may send instructions to device 110 to cause the corrections to be displayed. In other examples, system 125 may comprise a hosted software application that device 110 access via network 115, and system 125 may cause the feedback/corrections to be displayed on device 110. In examples, the system 125 may also send an electronic file with the corrections and/or feedback to device 110 or other device(s) associated with the individual who submitted the code.

For example, the code correction system 125 includes a testing system 130 that causes the code submission 120 to execute one or more predefined test cases to determine if the code in the code submission 120 was written correctly with respect to the programming assignment. If the testing system 130 determines that the code in the code submission 120 was written correctly (e.g., the code submission correctly executes the one or more test cases), the code submission 120 is identified as a correct code submission. In some examples, the correct code submission is stored in a storage system 140. Once the correct code submission is stored in the storage system 140, it may be used to correct incorrect code submissions such as will be described below.

The code correction system 125 also includes a control flow system 135. The control flow system 135 receives each code submission 120, regardless of whether the testing system 130 determines that the code submission 120 is a correct code submission or an incorrect code submission. The control flow system 135 is configured to generate a control flow representation for each code submission 120.

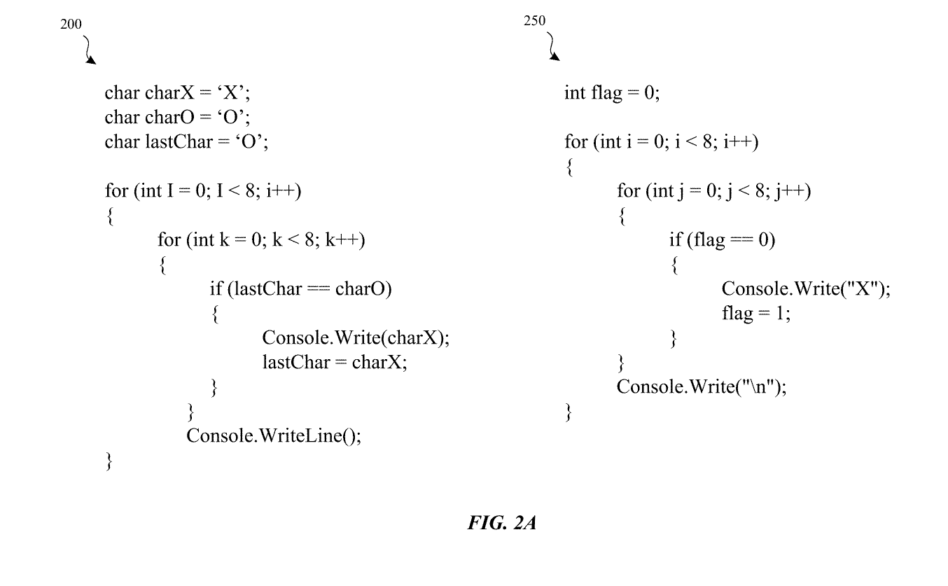

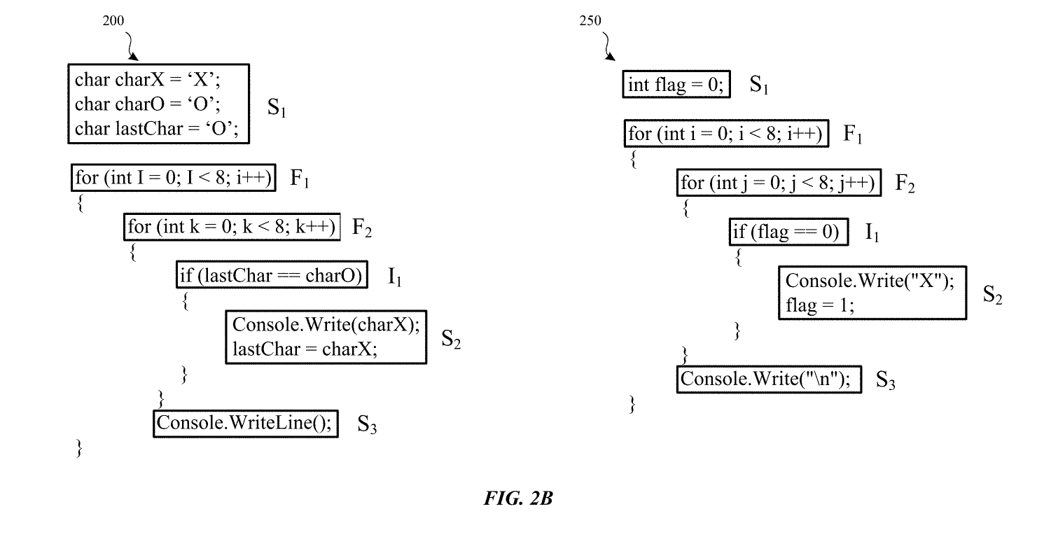

The control flow representation is a series of predefined characters, or alphabets, that represent each control block in the code submission. For example, the character “F” represents a for loop, the character “I” represents an if statement, the character “W” represents a while loop and so on. In addition to the above, in examples, the character “T” is used to signal the end of a control block and to represent a nesting relationship. Non-control statements may be compressed into a block represented by the character “S.” It is possible that a code submission can have many for loops, if statements, non-control statements and so on. As such, the control flow system 135 distinguishes the same characters or alphabets with a counter. An example of how the control flow system 135 generates a control flow representation will be shown and described with reference to FIG. 2A-FIG. 2B.

FIG. 2A shows two example segments of code, segment 1 200 and segment 2 250.

Each segment includes a number of different variables and different control blocks. For example, segment 1 200 includes the variables: charX, charO, lastChar, i, and k. Further segment 1 200 includes two for loops and an if statement. Likewise, segment 2 250 includes the variables: flag, i, and j and also includes two for loops and an if statement. In this example, segment 1 200 represents a code segment from a correct code submission and segment 2 250 represents a code segment from an incorrect code submission.

Using the rules set forth above, each of these code segments may be represented as a control flow representation. For example, and turning to FIG. 2B, each code block of segment 1 200 is represented as a character. Likewise, each code block of segment 2 250 may also be represented as a character. For example, in segment 1 200, the declarations of the variables charX, charO and lastChar are represented by S₁. Likewise, the for loops are represented as F₁ and F₂ respectively. Thus, segment 1 200 can be represented by the control flow representation of S₁, F₁, F₂, I₁, S₂ and S₃. Likewise segment 2 250 can also be represented by the control flow representation S₁, F₁, F₂, I₁, S₂ and S₃ even though different variables were used.

Referring back to FIG. 1, once the control flow system 135 has generated the control flow representation, correct control flow representations (e.g., control flow representations that were generated from correct code submissions) are stored in a storage system 140. In some implementations, the correct code submission from which the correct control flow representation was generated is also stored in the storage system 140.

The storage system 140 is configured to cluster or group similar correct control flow representations together. Continuing with the example above, any correct code submission that is represented by the control flow representation S₁, F₁, F₂, I₁, S₂ and S₃ will be grouped with segment 1 200 (FIG. 2A). The grouping enables the code correction system 125 to find matches, and thus corrections, for incorrect code submissions that are received.

For example, and referring back to FIG. 2B, even though segment 2 250 was identified as an incorrect code submission, it is still associated with the control flow representation S₁, F₁, F₂, I₁, S₂ and S₃. Thus, as the code correction system 125 attempts to find correct code submissions that may be used to correct the incorrect code submission, the incorrect code submission will be compared with the correct code submissions that share matching control flow representation (e.g., the incorrect code submission will be compared with all the correct code submissions with the control flow representation S₁, F₁, F₂, I₁, S₂ and S₃).

While correct control flow representations and their associated correct code submissions are stored in the storage system 140, incorrect control flow representations, along with their respective incorrect code submissions, are provided to a repair system 145. In some examples, the repair system 145 is integrated with the code correction system 125. In other implementations, the repair system 145 is a separate system and may be accessible to the code correction system 125 using a network or other connection.

The repair system 145 includes various other sub-systems. These include a searching system 150, a comparison system 155, and a minimizing system 160. Each of these sub-systems may work together to determine what changes need to be made to the incorrect code submission so that it will correctly execute the test cases hosted by the testing system 130.

For example, once the control flow system 135 generates the incorrect control flow representation from the incorrect code submission, the incorrect control flow representation is provided to the searching system 150. The searching system 150 performs a hierarchical search in the storage system 140 to find correct code submission that are similar to the incorrect code submission. In some cases, the search is a two-level search.

The first level search is a search for correct code submissions that have matching control flow representation structure. Continuing with the example above, if the incorrect code submission has an incorrect control flow representation of S₁, F₁, F₂, I₁, S₂ and S₃, the searching system 150 searches for correct control flow representations having matching structure (e.g., correct control flow representations of S₁, F₁, F₂, I₁, S₂ and S₃).

In some cases, the storage system 140 stores the correct control flow representations in a cluster or group. Thus, every correct code submission that has matching correct control flow representations (e.g., S₁, F₁, F₂, I₁, S₂ and S₃) are grouped together.

Once the searching system 150 finds a cluster of correct control flow representations that match the incorrect control flow representation from the incorrect code submission, the searching system 150 proceeds to the second level of searching in which the non-control flow statements and/or expressions from the incorrect code submission are matched with the non-control flow statements and/or expressions of the correct code submissions that are associated with the correct control flow representations.

In order to match the non-control flow statements from the incorrect code submission to the non-control flow statements of the correct code submission, the repair system 145 generates an abstract syntax tree for the incorrect code submission and the correct code submission. As will be appreciated, an abstract syntax tree is a representation of the source code in each code submission 120. Each node in the abstract syntax tree represents a construct that occurs in the source code.

However, in some cases, the variables used in the incorrect code submission may not match the variables used in the correct code submission. As such, it may be difficult to compare and/or match the non-control flow statements from each submission. Accordingly, the searching system 150 (or another system of the repair system 145) is configured to rename the variables used in the incorrect code submission to match those used in the correct code submission.

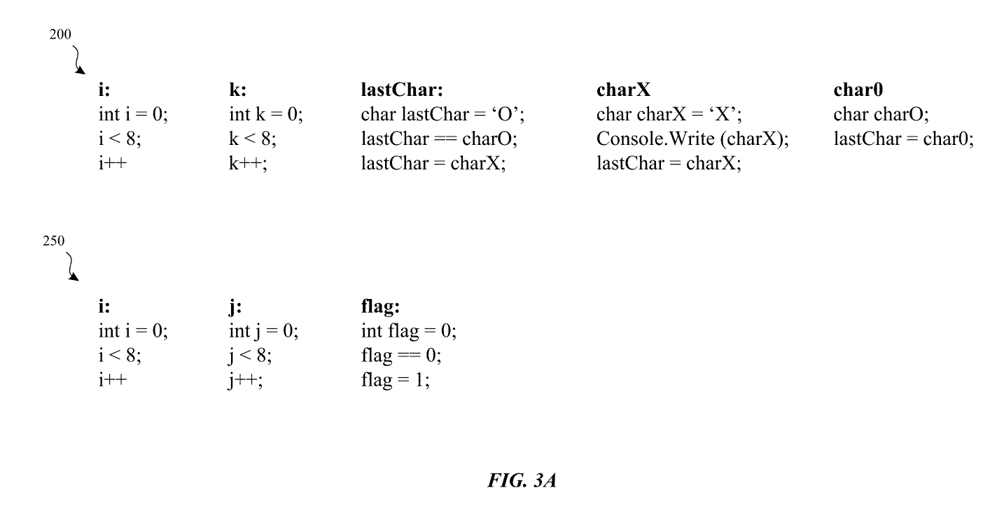

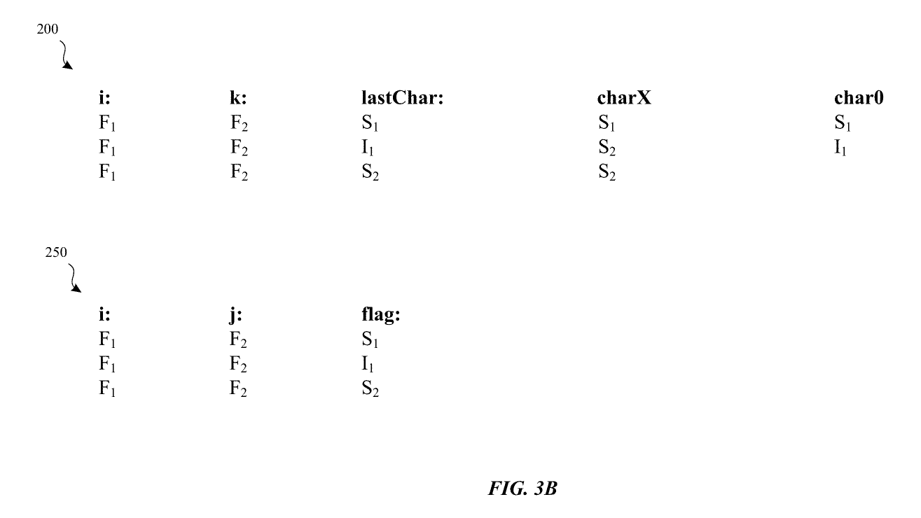

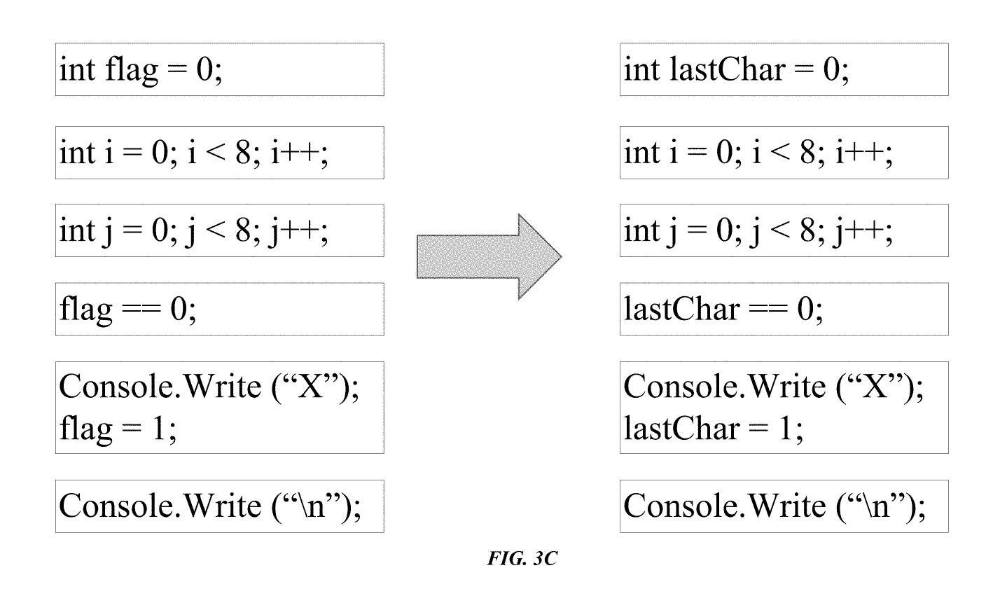

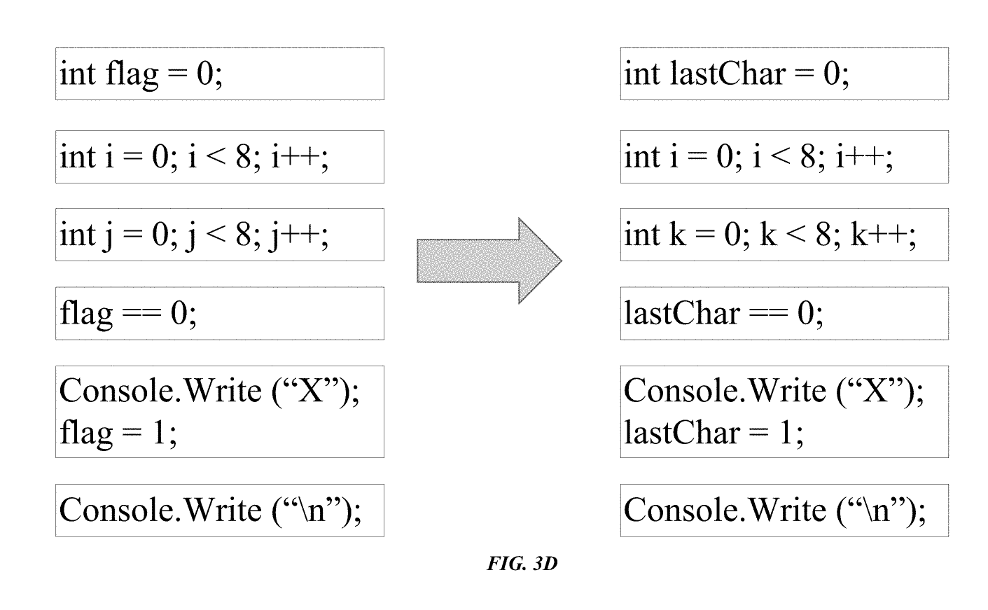

For example and referring to FIG. 3A, searching system 150 extracts the statements for each of the variables in the correct code submission (e.g., segment 1 200 shown in FIG. 2A) and the statements of the variables in the incorrect code submission (e.g., segment 2 250 shown in FIG. 2A). Variables with the same operations, even though they may be named differently, are matched. For example and as shown in FIG. 3A, the variable i in code segment 1 200 is matched with the variable i in code segment 2 250 because they have the same operations. Likewise, the variable k in code segment 1 200 is matched with variable j in code segment 2 250 because they have the same operations. Additionally, the variable lastChar in code segment 1 200 is matched with the variable flag in code segment 2 250 as they have the same operations. In this example the variables charX and charO in code segment 1 200 do not have corresponding variables in code segment 2 250.

Once this mapping has occurred, the searching system 150 represents each variable using its respective control flow characters or alphabets. For example and turning to FIG. 3B, the variable is replaced by the control flow block to which the variable belongs. Thus, variable i in code segment 1 200 is replaced by F₁, F₁, F₁ as that variable is used in the first for loop of code segment 1 200 (See FIG. 2B). Likewise, variable k in code segment 1 200 is replaced by F₂, F₂, F₂, variable lastChar is replaced by S₁, I₁, S₂ and so on.

The same process occurs for the variables in code segment 2 250. For example, the variable i in code segment 2 250 is replaced by F₁, F₁, F₁, the variable j is replaced by F₂, F₂, F₂, and the variable flag is replaced by S₁, I₁, S₂.

Variables having the same control flow structure can now be substituted for one another. For example, because variable k in code segment 1 200 has the same control flow structure (F₂, F₂, F₂) as the variable j in code segment 2 250, the variable j in code segment 2 250 can be replaced by the variable k in code segment 1 200. Likewise, the variable flag in code segment 2 250 can be replaced by the variable lastChar from code segment 1 200. These replacement operations are shown in FIG. 3C and FIG. 3D respectively.

For example, the variable flag in code segment 2 250 is replaced with the variable lastChar (shown in FIG. 3C) and the variable j in code segment 2 250 is replaced with the variable k (shown in FIG. 3D). Once the variables in the incorrect code submission match the variables in the correct code submission, the repair system 145 can determine how to change the incorrect code submission so that it correctly executes the test cases and performs similarly to the correct code submission.

Once this process is complete, the searching system 150 generates abstract syntax trees for each of the incorrect code submission and for every correct code submission in the identified cluster of correct control flow representations (e.g., every correct code submission that has a control flow representation matching S₁, F₁, F₂, I₁, S₂ and S₃). The similarity between the various non-control statements or expressions in each abstract syntax tree can then be measured.

In some examples, the similarity is defined as the maximum number of matching nodes (e.g., nodes that have the same or similar non-control statements and/or expressions) in the two abstract syntax trees over the total number of nodes in the two abstract syntax trees. In some cases, two non-leaf nodes in the abstract syntax trees are considered to be a match if they represent identical types of expressions such as parenthesis, binary operations, method invocation and so on. Leaf nodes are considered to be a match if they have the same identifier, operator, literals, and so on.

Additionally, matching two nodes in the context of trees may also require two additional constraints: 1) any node in one abstract syntax tree can match one and only one node in the other abstract syntax tree and vice versa; and 2) any two nodes in an ancestral relationship in one abstract syntax tree must match two nodes in the same relationship in the other abstract syntax tree and vice versa.

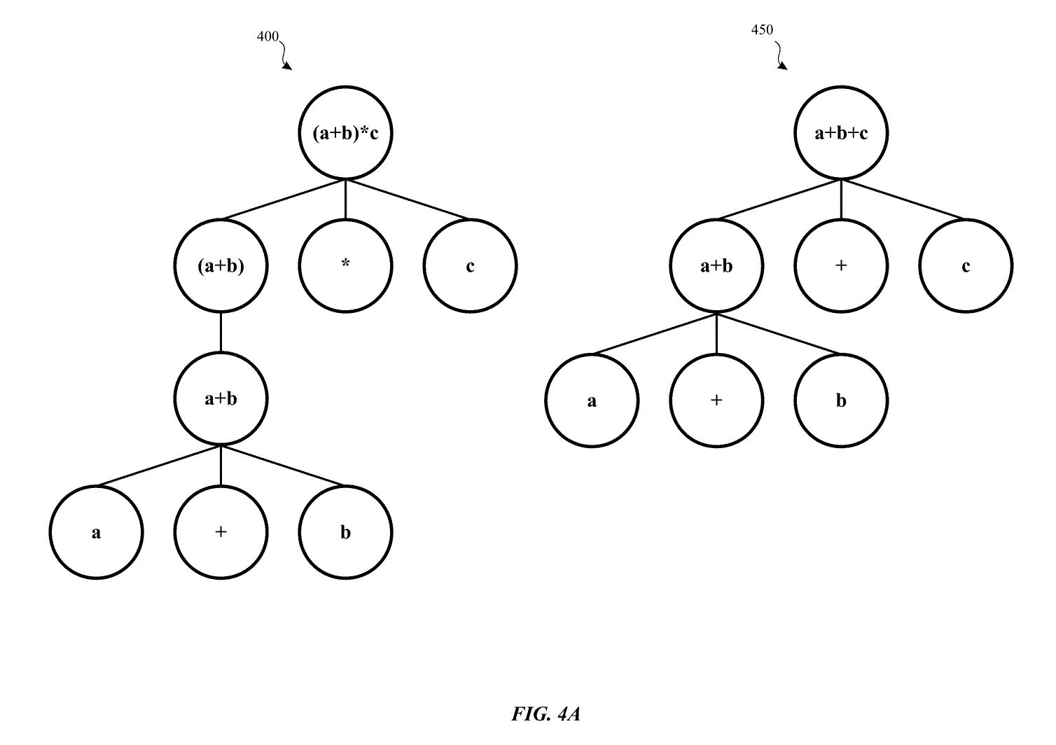

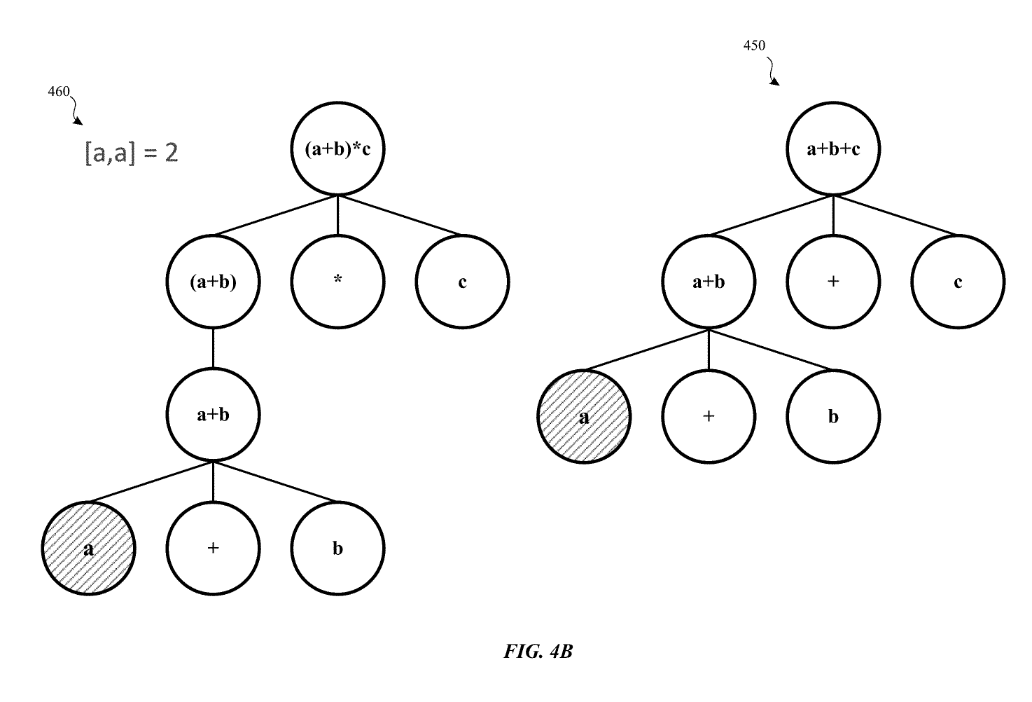

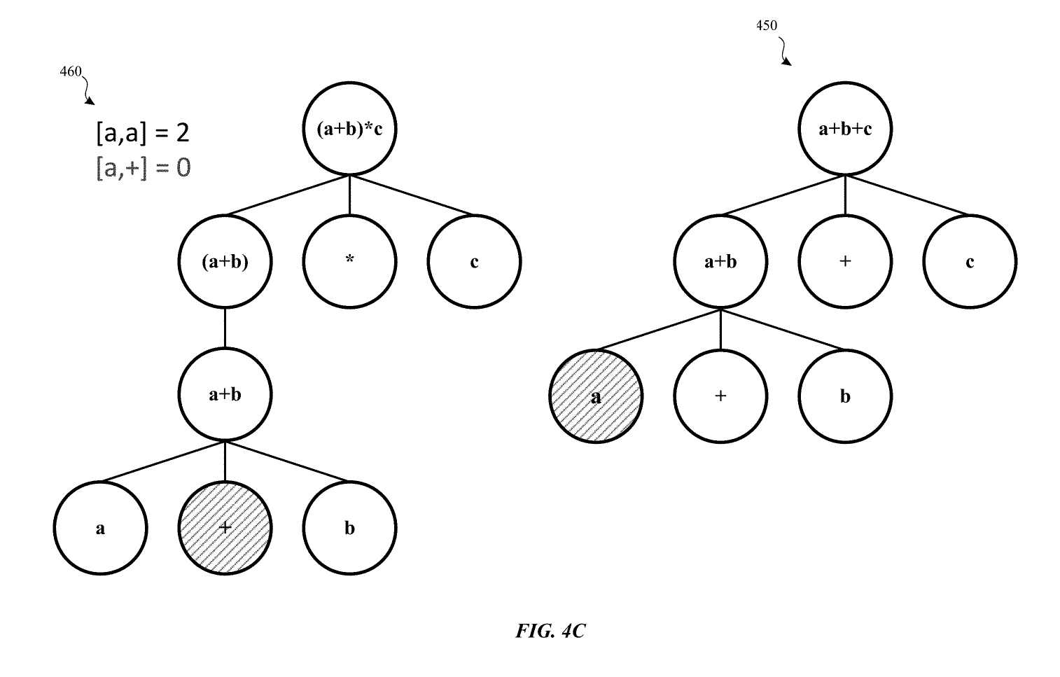

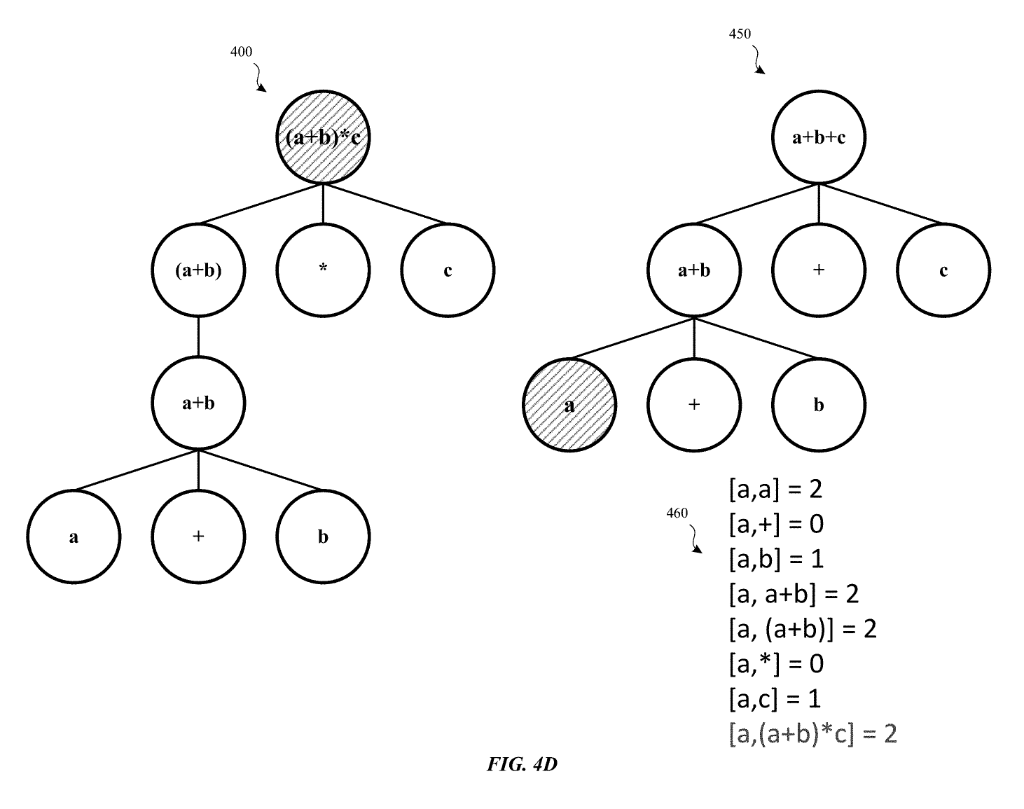

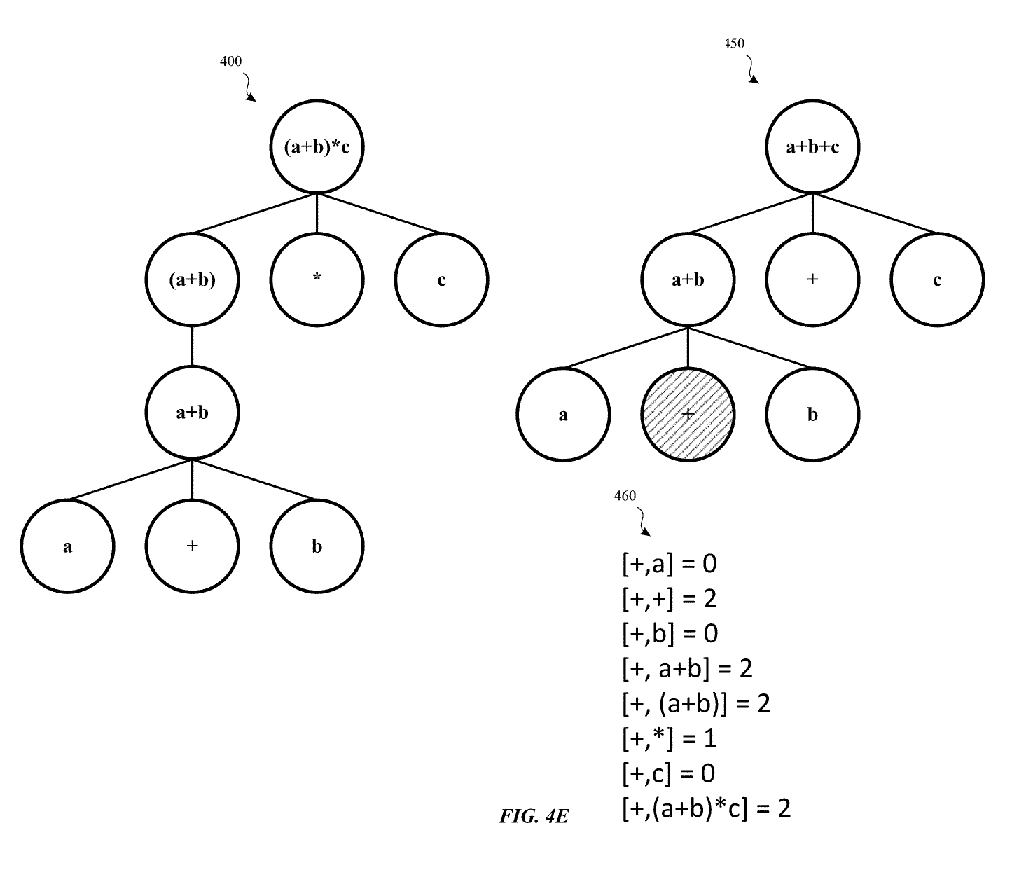

The matching process between a first abstract syntax tree 400 and a second abstract syntax tree 450 will now be described with respect to FIGS. 4A-4E. As shown, the first abstract syntax tree 400 has a root node of (a+b)*c and the second abstract syntax tree 450 has a root node of a+b+c. Each abstract syntax tree includes nodes that represent a sub-part of the entire expression. In order to determine a matching distance between the two abstract syntax trees, both abstract syntax trees are traversed in a bottom-up fashion and the nodes in each tree are compared to one another. The searching system 150 then takes the maximum matching result from three conditions.

These conditions will be explained using two example abstract syntax trees referred to as T₁ and T₂. In the following explanation, T₁ is rooted at α and T₂ is rooted at β. The first condition states that α is directly matched with β. In this case, the maximum number of matching nodes will be equal to total maximum number of matching nodes from each of the subtrees rooted at the each of the children nodes of α and β, in order, plus an additional score of 1 is added if α, is a direct match to β. The second condition specifies that if a, is matched with γ, γ being a descendent node of β, the maximum number of matching nodes will be equal to that between T₁ and the tree rooted at γ. The third condition specifies that α's descendent node, ε, is matched with β. In this case, the maximum number of matching nodes will be equal to that T₂ and the tree rooted at ε. Further, leaf nodes have a matching score of 2, while other matching nodes have a score of 1.

For example and turning to FIG. 4B, the matching between the two abstract syntax trees 400 and 450 begins at bottom left most node and moves up the tree. A matching score 460 for each node is then determined. Because the bottom most node in the first abstract syntax tree 400 (e.g., the node “a”) matches the bottom most node in the second abstract syntax tree 450, the pair [a,a] is given a matching score of 2. The next node (e.g., the node “+”) of the first abstract syntax tree 400 is then matched with the bottom most node of the second abstract syntax tree 450. This is shown in FIG. 4C. The pair [a,+] is given a matching score 460 of 0. This process repeats until each node in the first abstract syntax tree 400 has been compared to the bottom most node in the second abstract syntax tree 450. This comparison, along with the respective matching scores 460, are shown in FIG. 4D.

The process continues with the next node (e.g., the “+” node) in the second abstract syntax tree 450. The comparison of each node, along with its respective score 460, is shown in FIG. 4E.

Using the process described above, the maximum number of matching nodes between the two abstract syntax trees is determined. For example, the maximum number of matching nodes for the atomic trees rooted at the leaf nodes is determined and then propagated in a bottom-up fashion until the root is reached. The correct code submission having the abstract syntax tree with the highest score, is determined to be the best match. In some cases, multiple abstract syntax trees and their associated correct code submissions may be selected as best matches.

Once the searching system 150 has identified the correct code submission that is most similar to the incorrect code submission using the above-described process, the comparison system 155 determines various operations (e.g., edit operations, delete operations, insert operations) that can be used to transform or otherwise change the incorrect code submission to match the correct code submission.

For example, given the matching between the first abstract syntax tree 400 and the second abstract syntax tree 450, the comparison system 155 recursively traces the roots of each abstract syntax tree to find the optimal path and produces the operations based on the matching scenarios in a top-down manner.

For example, the matching between a+b+c and (a+b)*c stemming from the first condition (e.g., α is directly matched with β—in this case, the maximum number of matching nodes will be equal to total maximum number of matching nodes from each of the subtrees rooted at the each of the children nodes of α and β, in order, plus an additional score of 1 is added if α, is a direct match to β) suggests that an edit operation that changes a+b+c to (a+b)*c. In addition, the matching scenario also entails that (a+b) in the first abstract syntax tree 400 and a+b in second abstract syntax tree 450 will become the subsequent roots for consideration. This time their matching will be based on the second condition (e.g., if α, is matched with γ, γ being a descendent node of β, the maximum number of matching nodes will be equal to that between T1 and the tree rooted at γ) that indicates an insertion operation (e.g., adding the (a+b) in the first abstract syntax tree 400 in between a+b+c and a+b in the second abstract syntax tree 450) may be used to transform the second abstract syntax tree 450 into the first abstract syntax tree 400. This process may continue until both abstract syntax trees match.

Once the comparison system 155 has determined the edits that need to be made to the incorrect code submission, it may be determined that not all of the fixes need to be made to the incorrect code submission to repair it. Accordingly, the minimizing system 160 is configured to discover a minimum set of fixes that can be made to the incorrect code submission in order for it to function correctly. Accordingly, the minimizing system 160 uses each subset of all the determined fixes to determine the minimum amount of edits that can be made to the incorrect code submission for it to function properly. In some cases, the maximum number of edits is three although this number may vary.

Once the minimum number of fixes has been determined, an output system 165 provides the suggested changes (shown as code correction 170), along with the incorrect code submission to the individual that originally submitted the incorrect code submission.

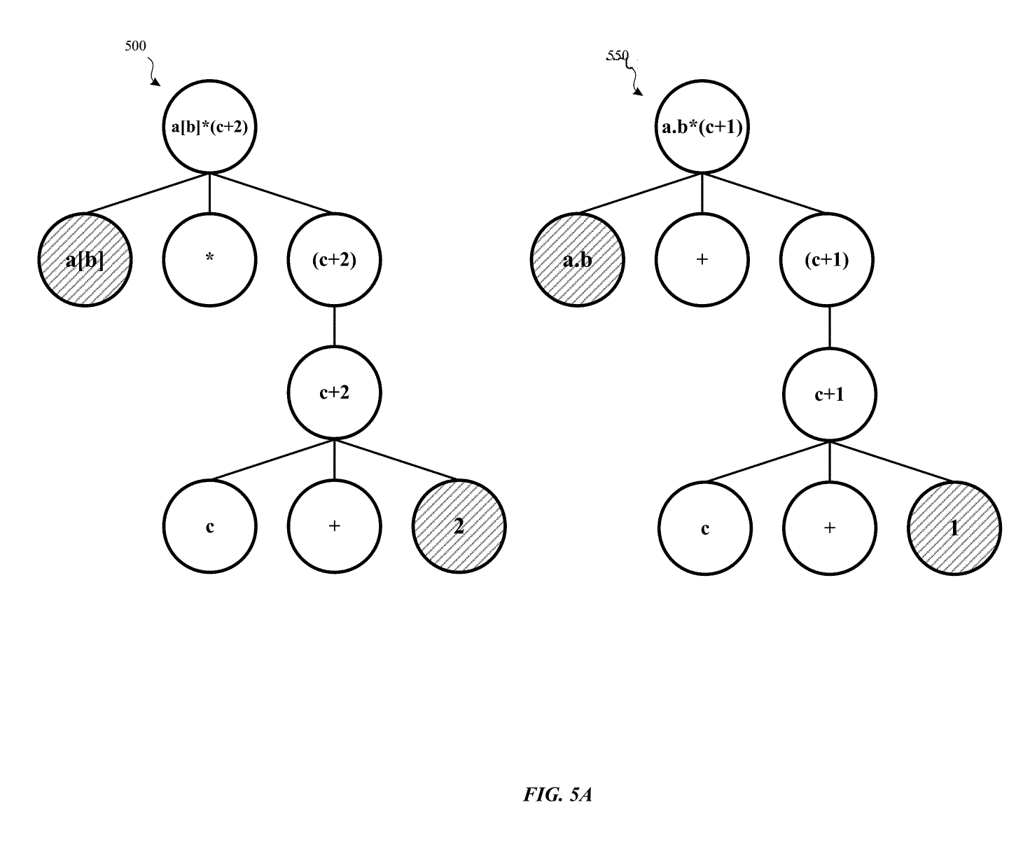

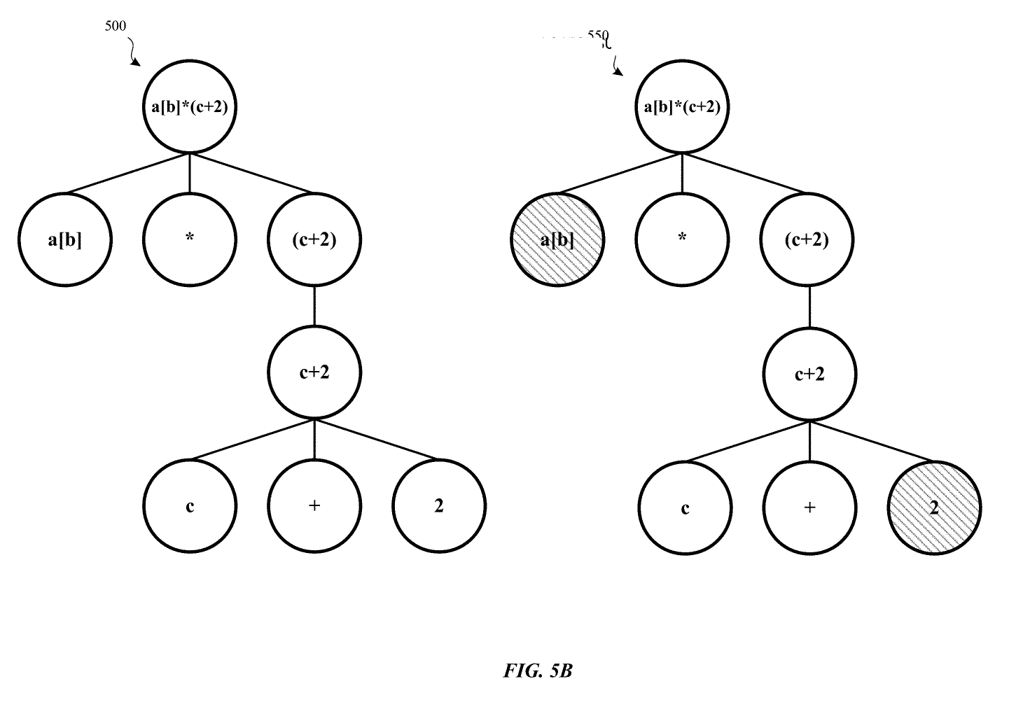

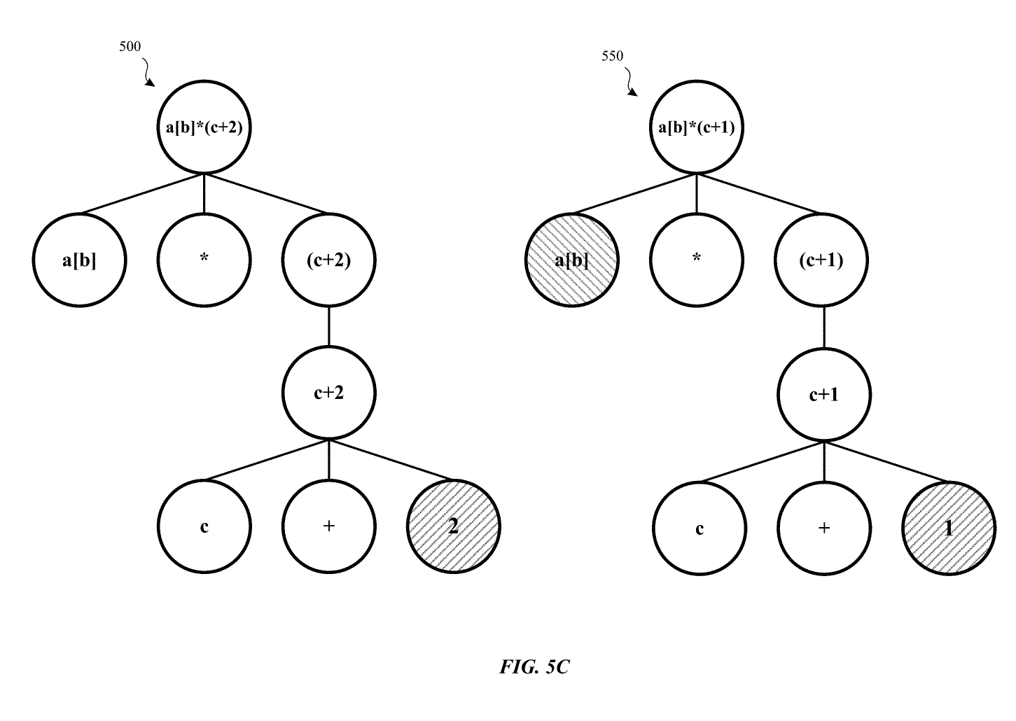

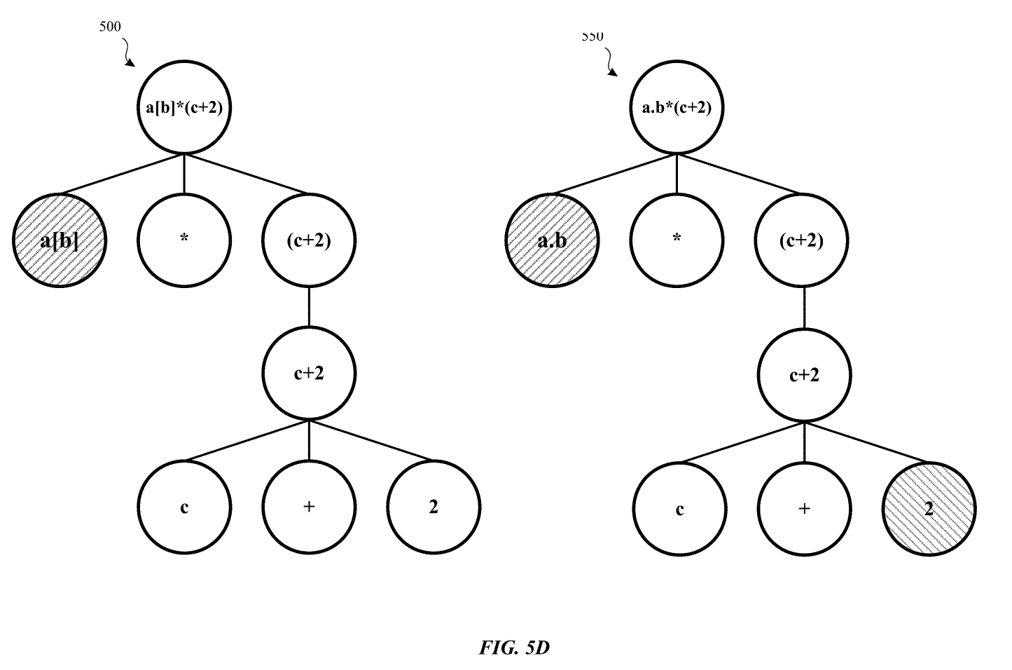

FIG. 5A-FIG. 5D show an example of how the comparison system 155 and the minimizing system 160 work together to find the minimum number of changes that need to made to an abstract syntax tree associated with an incorrect code submission. In this example, the first abstract syntax tree 500 is generated from a correct code submission and the second abstract syntax tree 550 is generated from an incorrect code submission.

As shown in FIG. 5A, the first abstract syntax tree 500 has a root node of a[b]*(c+2). The root node of the second abstract syntax tree 550 has a root node of a·b*(c+1). These differences are then propagated along the various other nodes of each of the abstract syntax trees. For example, the bottom most right node of the first abstract syntax tree 500 is a 2 while the bottom most right node of the second abstract syntax tree 550 is a 1.

As shown in FIG. 5B, in order to change second abstract syntax tree 550 to match the second abstract syntax tree 500, the node having a·b in the second abstract syntax tree 550 is replaced with a[b]. Likewise, the node in the second abstract syntax tree 500 having a 1 is changed to a 2. Once these changes have been made by the comparison system 155, the minimizing system 160 may set a maximum number of fixes or changes that can be made to second abstract syntax tree 550 (e.g., a maximum threshold of three).

The minimizing system 160 then exhaustively tries out all subsets of the fixes up to three. For example, as shown in FIG. 5C, only one change is made—a·b in the second abstract syntax tree is changed to a[b]. If that change does not correct the incorrect code submission, the minimizing system 160 tries the next change.

For example and turning to FIG. 5D, the node in the second abstract syntax tree 550 containing the 1 is changed to a 2 and this change is propagated up the second abstract syntax tree 550. If this change does not correct the incorrect code submission, both nodes are changed and the incorrect code submission is executed again. This process repeats until the minimum number of fixes are found to correct the incorrect code submission.

Although the examples described above disclose how to correct an incorrect code submission, the system 100 herein may be used to compare correct code submissions against other correct code submissions and provide feedback and/or changes that can make the correct code submissions more efficient.

For example, the testing system 130 may be configured to determine how efficiently each correct code submission executes the various test cases and may associate an efficiency score with each correct code submission. When a correct code submission with a low efficiency score is received, the searching system 150 can compare the control flow representation of the correct code submission with other correct control flow representations having higher efficiency scores and provide feedback and/or comments in the same manner as described with respect to incorrect code submissions.

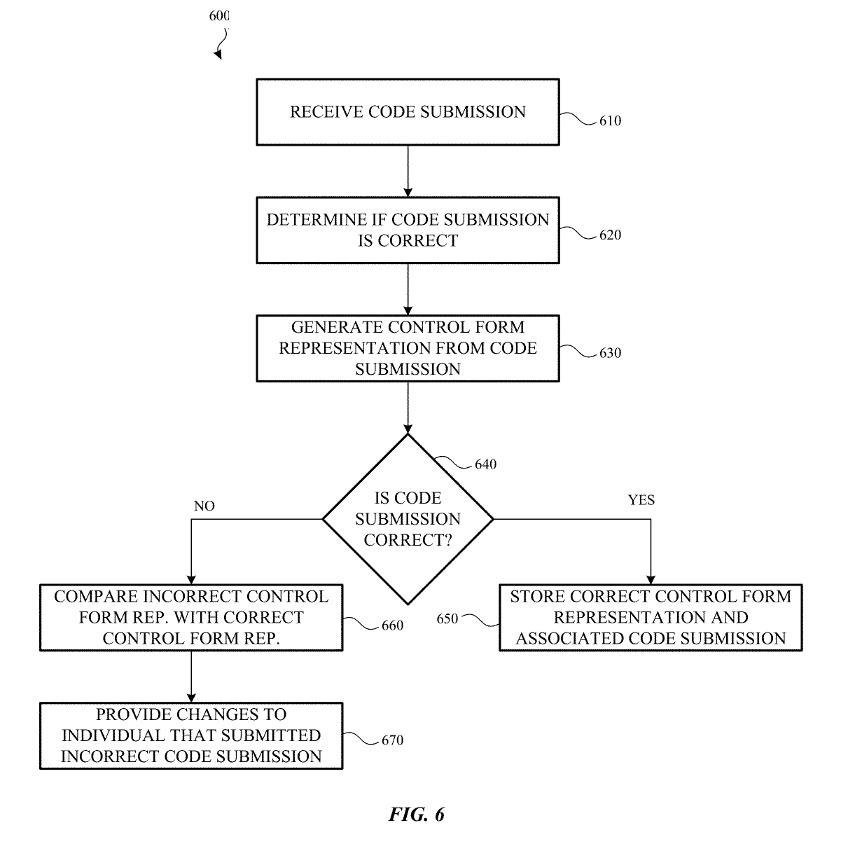

FIG. 6 illustrates a method 600 for automatically providing feedback for an incorrect code submission. In some examples, the method 600 may be used by the system 100 such as described above with respect to FIG. 1.

Method 600 begins at operation 610 in which a code submission is received. In examples, the code submission is received from a device operated by an individual who is enrolled in a programming course such as described above. The code submission may be submitted to solve a particular programming assignment in the programming course.

Once the code submission is received, flow proceeds to operation 620 and a determination is made as to whether the code submission is correct. For example, the code submission may be executed on one or more test cases to determine whether the code submission complies with the requirements set forth in the programming assignment.

Flow then proceeds to operation 630 and a control form representation of the code submission is generated. In some examples, the control form representation is generated for each code submission, regardless of whether the code submission is correct or incorrect.

If it was determined in operation 620 that the code submission was correct, operation 640 causes flow proceeds to operation 650 and the correct control form representation, and its associated code submission, is stored in a storage device. In examples, code submissions that have the same or similar control form representations are clustered or otherwise stored together so that they can be used as references for incorrect code submissions that have the same or similar control form representations.

When it is determined in operation 620 that the code submission is incorrect, operation 640 causes flow to proceed to operation 660 and the incorrect control form representation that was generated from the incorrect code submission is compared against one or more correct control form representations. When similar control form representations have been found, the incorrect code submission is compared against the correct code submission in order to determine changes that need to be made to the incorrect code submission.

In operation 670, the determined changes are caused to be displayed and/or otherwise provided to the individual that submitted the incorrect code submission.

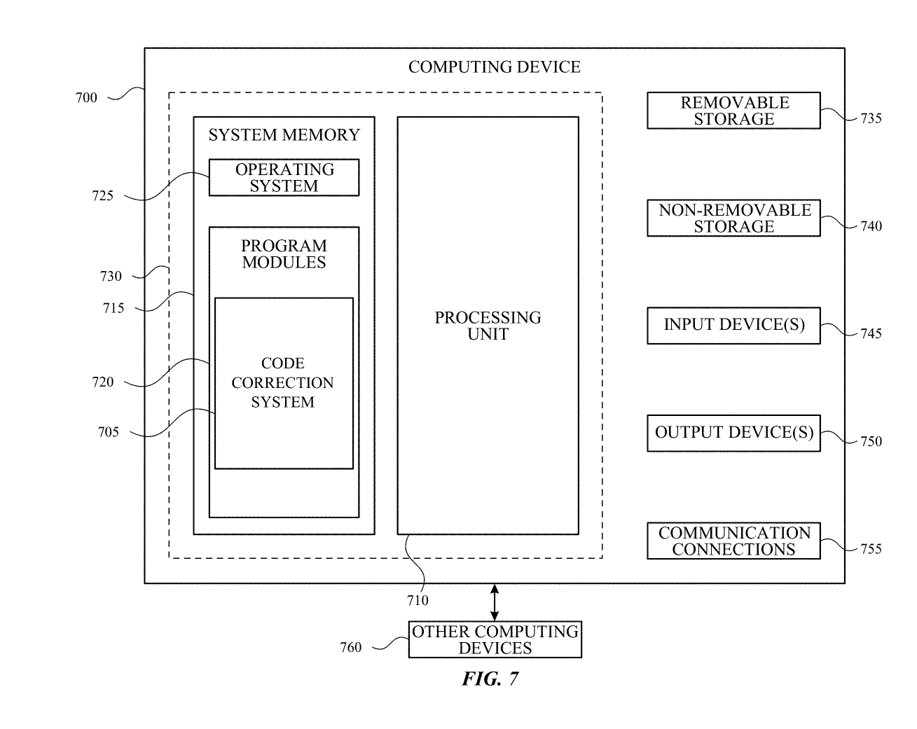

FIGS. 7-10 and the associated descriptions provide a discussion of a variety of operating environments in which aspects of the disclosure may be practiced. However, the devices and systems illustrated and discussed with respect to FIGS. 7-10 are for purposes of example and illustration and are not limiting of a vast number of electronic device configurations that may be utilized for practicing aspects of the disclosure, as described herein.

FIG. 7 is a block diagram illustrating physical components (e.g., hardware) of an electronic device 700 with which aspects of the disclosure may be practiced. The components of the electronic device 700 described below may have computer executable instructions for causing a code correction system 705 to feedback about received code submissions such as described above.

In a basic configuration, the electronic device 700 may include at least one processing unit 710 and a system memory 715. Depending on the configuration and type of electronic device, the system memory 715 may comprise, but is not limited to, volatile storage (e.g., random access memory), non-volatile storage (e.g., read-only memory), flash memory, or any combination of such memories. The system memory 715 may include an operating system 725 and one or more program modules 720 suitable for correcting code submission such as described herein.

The operating system 725, for example, may be suitable for controlling the operation of the electronic device 700. Furthermore, examples of the disclosure may be practiced in conjunction with a graphics library, other operating systems, or any other application program and is not limited to any particular application or system. This basic configuration is illustrated in FIG. 7 by those components within a dashed line 730.

The electronic device 700 may have additional features or functionality. For example, the electronic device 700 may also include additional data storage devices (removable and/or non-removable) such as, for example, magnetic disks, optical disks, or tape. Such additional storage is illustrated in FIG. 7 by a removable storage device 735 and a non-removable storage device 740.

As stated above, a number of program modules and data files may be stored in the system memory 715. While executing on the processing unit 710, the program modules 720 (e.g., the code correction module 705, which may comprise code correction system 125) may perform processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 700 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general purpose computer or in any other circuits or systems.

The electronic device 700 may also have one or more input device(s) 745 such as a keyboard, a trackpad, a mouse, a pen, a sound or voice input device, a touch, force and/or swipe input device, etc. The output device(s) 750 such as a display, speakers, a printer, etc. may also be included. The aforementioned devices are examples and others may be used. The electronic device 700 may include one or more communication connections 755 allowing communications with other electronic devices 760. Examples of suitable communication connections 755 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 715, the removable storage device 735, and the non-removable storage device 740 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 700. Any such computer storage media may be part of the electronic device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

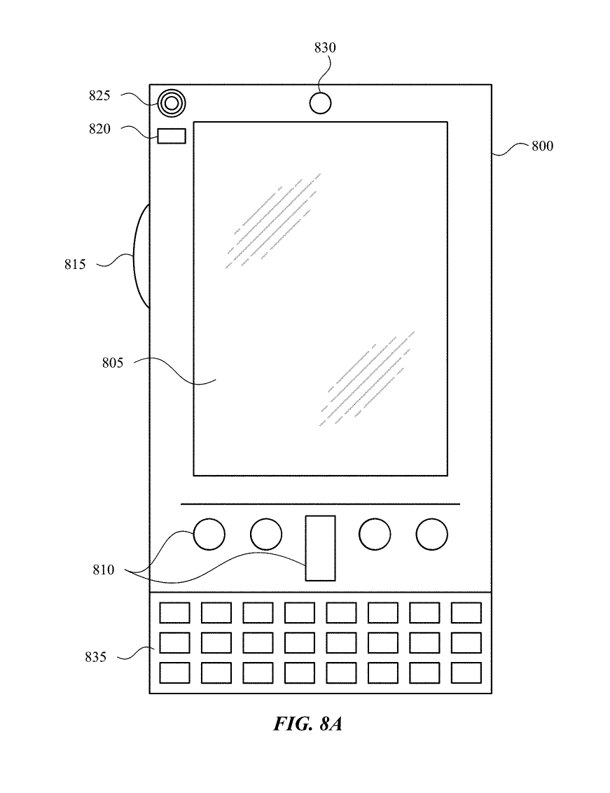

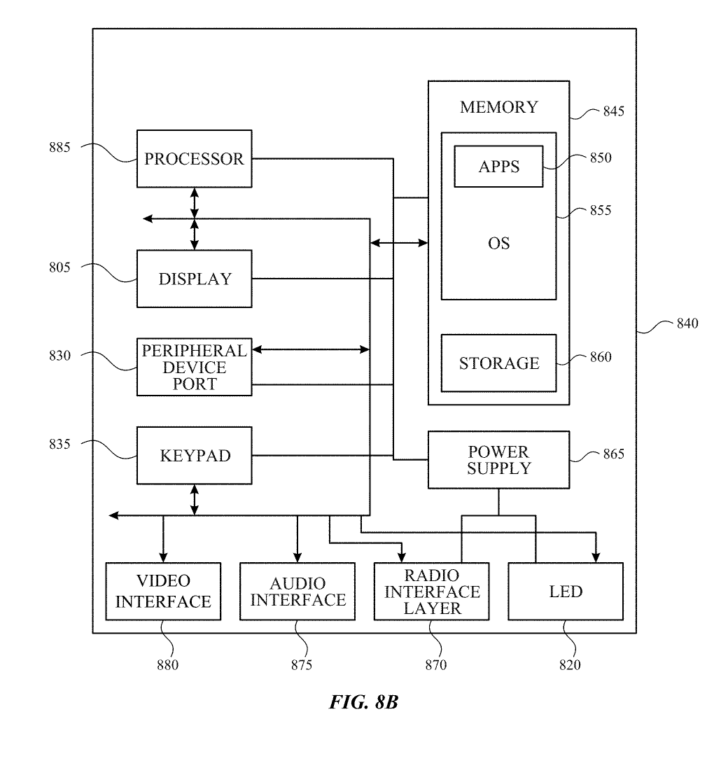

FIGS. 8A and 8B illustrate a mobile electronic device 800, for example, a mobile telephone, a smart phone, wearable computer (such as a smart watch), a tablet computer, a laptop computer, and the like, with which examples of the disclosure may be practiced. With reference to FIG. 8A, one aspect of a mobile electronic device 800 for implementing the aspects is illustrated.

In a basic configuration, the mobile electronic device 800 is a handheld computer having both input elements and output elements. The mobile electronic device 800 typically includes a display 805 and one or more input buttons 810 that allow the user to enter information into the mobile electronic device 800. The display 805 of the mobile electronic device 800 may also function as an input device (e.g., a display that accepts touch and/or force input).

If included, an optional side input element 815 allows further user input. The side input element 815 may be a rotary switch, a button, or any other type of manual input element. In alternative aspects, mobile electronic device 800 may incorporate more or less input elements. For example, the display 805 may not be a touch screen in some examples. In yet another alternative embodiment, the mobile electronic device 800 is a portable phone system, such as a cellular phone. The mobile electronic device 800 may also include an optional keypad 835. Optional keypad 835 may be a physical keypad or a “soft” keypad generated on the touch screen display.

In various examples, the output elements include the display 805 for showing a graphical user interface (GUI), a visual indicator 820 (e.g., a light emitting diode), and/or an audio transducer 825 (e.g., a speaker). In some aspects, the mobile electronic device 800 incorporates a vibration transducer for providing the user with tactile feedback. In yet another aspect, the mobile electronic device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile electronic device 800. That is, the mobile electronic device 800 can incorporate a system (e.g., an architecture) 840 to implement some aspects. In one embodiment, the system 840 is implemented as a “smart phone” capable of running one or more applications (e.g., browser, e-mail, calendaring, contact managers, messaging clients, games, media clients/players, content selection and sharing applications and so on). In some aspects, the system 840 is integrated as an electronic device, such as an integrated personal digital assistant (PDA) and wireless phone.

One or more application programs 850 may be loaded into the memory 845 and run on or in association with the operating system 855. Examples of the application programs include phone dialer programs, e-mail programs, personal information management (PIM) programs, word processing programs, spreadsheet programs, Internet browser programs, messaging programs, and so forth.

The system 840 also includes a non-volatile storage area 860 within the memory 845. The non-volatile storage area 860 may be used to store persistent information that should not be lost if the system 840 is powered down.

The application programs 850 may use and store information in the non-volatile storage area 860, such as email or other messages used by an email application, and the like. A synchronization application (not shown) also resides on the system 840 and is programmed to interact with a corresponding synchronization application resident on a host computer to keep the information stored in the non-volatile storage area 860 synchronized with corresponding information stored at the host computer.

The system 840 has a power supply 865, which may be implemented as one or more batteries. The power supply 865 may further include an external power source, such as an AC adapter or a powered docking cradle that supplements or recharges the batteries.

The system 840 may also include a radio interface layer 870 that performs the function of transmitting and receiving radio frequency communications. The radio interface layer 870 facilitates wireless connectivity between the system 840 and the “outside world,” via a communications carrier or service provider. Transmissions to and from the radio interface layer 870 are conducted under control of the operating system 855. In other words, communications received by the radio interface layer 870 may be disseminated to the application programs 850 via the operating system 855, and vice versa.

The visual indicator 820 may be used to provide visual notifications, and/or an audio interface 875 may be used for producing audible notifications via an audio transducer (e.g., audio transducer 825 illustrated in FIG. 8A). In the illustrated embodiment, the visual indicator 820 is a light emitting diode (LED) and the audio transducer 825 may be a speaker. These devices may be directly coupled to the power supply 865 so that when activated, they remain on for a duration dictated by the notification mechanism even though the processor 885 and other components might shut down for conserving battery power. The LED may be programmed to remain on indefinitely until the user takes action to indicate the powered-on status of the device.

The audio interface 875 is used to provide audible signals to and receive audible signals from the user (e.g., voice input such as described above). For example, in addition to being coupled to the audio transducer 825, the audio interface 875 may also be coupled to a microphone to receive audible input, such as to facilitate a telephone conversation. In accordance with examples of the present disclosure, the microphone may also serve as an audio sensor to facilitate control of notifications, as will be described below.

The system 840 may further include a video interface 880 that enables an operation of peripheral device 830 (e.g., on-board camera) to record still images, video stream, and the like.

A mobile electronic device 800 implementing the system 840 may have additional features or functionality. For example, the mobile electronic device 800 may also include additional data storage devices (removable and/or non-removable) such as, magnetic disks, optical disks, or tape. Such additional storage is illustrated in FIG. 8B by the non-volatile storage area 860.

Data/information generated or captured by the mobile electronic device 800 and stored via the system 840 may be stored locally on the mobile electronic device 800, as described above, or the data may be stored on any number of storage media that may be accessed by the device via the radio interface layer 870 or via a wired connection between the mobile electronic device 800 and a separate electronic device associated with the mobile electronic device 800, for example, a server computer in a distributed computing network, such as the Internet. As should be appreciated such data/information may be accessed via the mobile electronic device 800 via the radio interface layer 870 or via a distributed computing network. Similarly, such data/information may be readily transferred between electronic devices for storage and use according to well-known data/information transfer and storage means, including electronic mail and collaborative data/information sharing systems.

In examples, one or both of device 110 and code correction system 125 may comprise a system as shown in FIG. 8A and FIG. 8B. As should be appreciated, FIG. 8A and FIG. 8B are described for purposes of illustrating the present methods and systems and is not intended to limit the disclosure to a particular sequence of steps or a particular combination of hardware or software components.

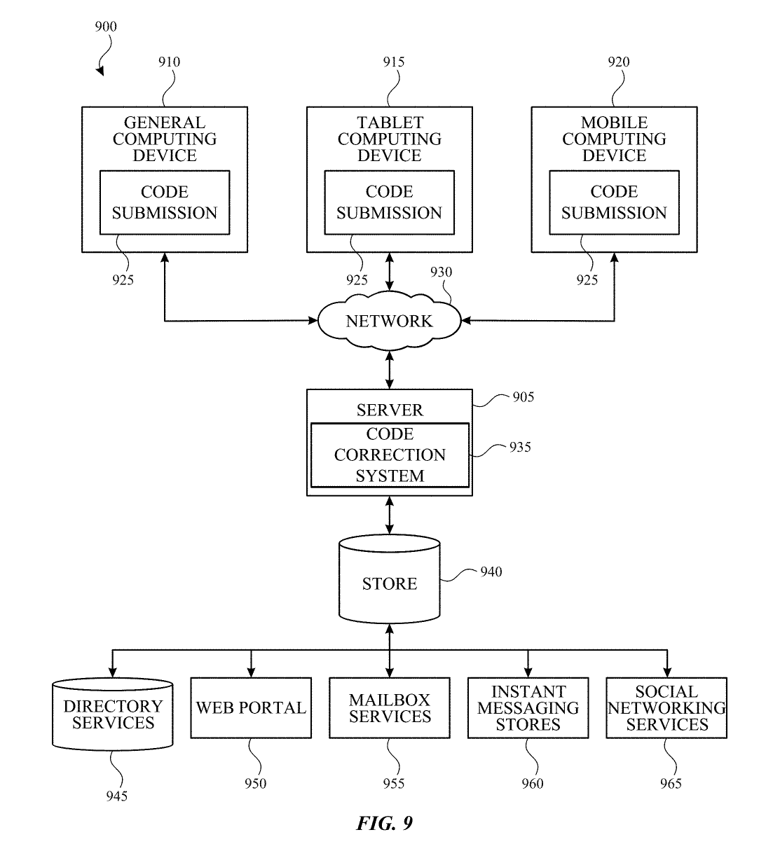

FIG. 9 illustrates one aspect of the architecture of a system 900 for automatically providing feedback and/or corrections for submitted code such as described herein. The system 900 may include a general electronic device 910 (e.g., personal computer), tablet electronic device 915, or mobile electronic device 920, as described above. Each of these devices may include be used to write or otherwise create a code submission 925.

In some aspects, each of the general electronic device 910 (e.g., personal computer), tablet electronic device 915, or mobile electronic device 920 may receive various other types of information or content that is stored by or transmitted from a directory service 945, a web portal 950, mailbox services 955, instant messaging stores 960, or social networking services 965.

In aspects, code submission 925 may be provided, through network 930, to a code correction system 935 hosted on a server 905. In examples, code correction system 935 may comprise code correction system 125.

By way of example, the aspects described above may be embodied in a general electronic device 910 (e.g., personal computer), a tablet electronic device 915 and/or a mobile electronic device 920 (e.g., a smart phone). Any of these examples of the electronic devices may obtain content from or provide data to the store 940.

As should be appreciated, FIG. 9 is described for purposes of illustrating the present methods and systems and is not intended to limit the disclosure to a particular sequence of steps or a particular combination of hardware or software components.

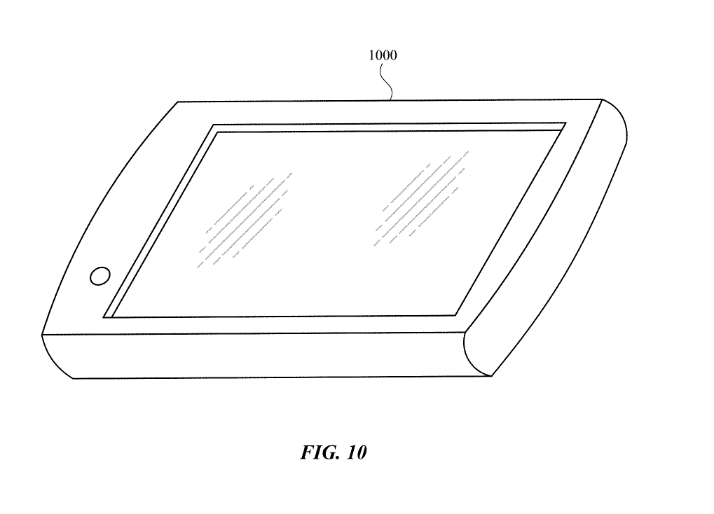

FIG. 10 illustrates an example tablet electronic device 1000 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices. For example, user interfaces and information of various types may be displayed and interacted with on a wall surface onto which user interfaces and information of various types are projected. Interaction with the multitude of computing systems with which examples of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, the figures herein FIG. 10 is described for purposes of illustrating the present methods and systems and is not intended to limit the disclosure to a particular sequence of steps or a particular combination of hardware or software components.

Aspects of the present disclosure describe a method for automatically correcting incorrect code submissions, comprising: generating an incorrect control flow representation of an incorrect code submission; comparing the incorrect control flow representation to a cluster of correct control flow representations, wherein each correct control flow representation in the cluster is associated with a set of correct code submissions; identifying one or more correct control flow representations that correspond to the incorrect control flow representation; comparing the incorrect code submissions with the correct code submission associated with each of the identified one or more correct control flow representations; generating one or more corrections to the incorrect code submission based on the comparison between the incorrect code submission and the correct code submissions; and providing the one or more corrections to an individual that submitted the incorrect code submission. In some examples, comparing the incorrect code submission with the correct code submission associated with each of the identified one or more correct control flow representations comprises generating abstract syntax trees for the correct code submissions and the incorrect code submission. In some examples, each node in the abstract syntax tree for the incorrect code submission is compared with each node in the abstract syntax tree for the correct code submission. In some examples, the comparison occurs in a bottom up manner. In some examples, a distance score between the abstract syntax tree for the incorrect code submission and the abstract syntax tree for the correct code submission is calculated using the comparison. In some examples, one or more variables in the correct code submission are represented as a first set of alphabets associated with the correct control flow representation and one or more variables in the incorrect code submission are represented as a second set of alphabets associated with the incorrect control flow representation. In some examples, the first set of alphabets is compared with the second set of alphabets. In some examples, the method also includes renaming at least one of the one or more variables in the incorrect code submission to match at least one of the one or more variables in the correct one or more of the code submission using the alphabets comparison. In some examples, the method also includes minimizing the one or more corrections.

Also described is a system comprising: at least one processing unit; and a memory storing computer executable instructions that, when executed by the at least one processing unit, cause the system to perform a method for providing automatic feedback for code submissions, comprising: receiving a plurality of code submissions; testing each of the plurality of code submissions using one or more test cases; identifying which of the plurality of code submissions correctly executes the one or more test cases; identifying which of the plurality of code submissions incorrectly executes the one or more test cases; generating a correct control flow representation for each code submission that correctly executes the one or more test cases; generating an incorrect control flow representation for each code submission that incorrectly executes the one or more test cases; and comparing each of the incorrect control flow representations to one or more of the correct control flow representations to determine one or more corrections to be made to a corresponding code submission that incorrectly executed the one or more test cases. In some examples, the instructions cause the one or more corrections to an individual who submitted the corresponding code submission that incorrectly executed the one or more test cases. In some examples, the correct control flow representations are arranged in a hierarchical manner. In some examples, the correct control flow representations are arranged in a cluster of similar correct control flow representations. In some examples, comparing each of the incorrect control flow representations to one or more of the correct control flow representations comprises determining which cluster includes correct control flow representations that match each of the incorrect control flow representations. In some examples, the instructions are for determining which of the one or more correct control flow representations in the cluster has a code submission that corresponds to a code submission associated with the incorrect control flow representation. In some examples, the instructions are for determining a distance metric between the code submission of each of the correct control flow representations in the cluster and the code submission associated with the incorrect control flow representation. In some examples, the instructions are for generating an abstract syntax tree for each code submission that correctly executes the one or more test cases and for each code submission that incorrectly executes the one or more test cases.

Also described is a computer-readable storage medium storing computer executable instructions which, when executed by a processing unit, causes the processing unit to perform a method for automatically correcting incorrect code submissions, comprising: receiving a code submission; testing the code submission using one or more test cases to determine whether the code submission is an incorrect code submission; when it is determined that the code submission is an incorrect code submission: generating an incorrect control flow representation of the incorrect code submission; comparing the incorrect control flow representation to a cluster of correct control flow representations, wherein each correct control flow representation in the cluster is associated with a correct code submission; identifying one or more correct control flow representations that correspond to the incorrect control flow representation; comparing the incorrect code submission with the correct code submissions associated with each of the identified one or more correct control flow representations; generating one or more corrections to the incorrect code submission based on the comparison between the incorrect code submission and the correct code submission; and providing the one or more corrections to an individual that submitted the incorrect code submission. In some examples, instructions are for generating a correct control flow representation of the code submission when it is determined, using the one or more test cases, that the code submission is a correct code submission. In some examples, the instructions are for: storing the correct control flow representation, along with the associated code submission in a database; and associating the correct control flow representation with other correct control flow representations that have a similar control flow.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for automatically correcting incorrect code submissions, comprising:
generating an incorrect control flow representation of an incorrect code submission;
comparing the incorrect control flow representation to a cluster of correct control flow representations, wherein each correct control flow representation in the cluster is associated with a set of correct code submissions;
identifying one or more correct control flow representations that correspond to the incorrect control flow representation;
comparing the incorrect code submissions with the correct code submission associated with each of the identified one or more correct control flow representations;
generating one or more corrections to the incorrect code submission based on the comparison between the incorrect code submission and the correct code submissions; and
providing the one or more corrections to an individual that submitted the incorrect code submission.

2. The method of claim 1, wherein comparing the incorrect code submission with the correct code submission associated with each of the identified one or more correct control flow representations comprises generating abstract syntax trees for the correct code submissions and the incorrect code submission.

3. The method of claim 2, further comprising comparing each node in the abstract syntax tree for the incorrect code submission with each node in the abstract syntax tree for the correct code submission.

4. The method of claim 3, wherein the comparison occurs in a bottom up manner.

5. The method of claim 3, further comprising calculating a distance score between the abstract syntax tree for the incorrect code submission and the abstract syntax tree for the correct code submission using the comparison.

6. The method of claim 1, further comprising representing one or more variables in the correct code submission as a first set of alphabets associated with the correct control flow representation and representing one or more variables in the incorrect code submission as a second set of alphabets associated with the incorrect control flow representation.

7. The method of claim 6, comparing the first set of alphabets with the second set of alphabets.

8. The method of claim 7, further comprising renaming at least one of the one or more variables in the incorrect code submission to match at least one of the one or more variables in the correct one or more of the code submission using the alphabets comparison.

9. The method of claim 1, further comprising minimizing the one or more corrections.

10. A system comprising:
at least one processing unit; and
a memory storing computer executable instructions that, when executed by the at least one processing unit, cause the system to perform a method for providing automatic feedback for code submissions, comprising:
receiving a plurality of code submissions;
testing each of the plurality of code submissions using one or more test cases;
identifying which of the plurality of code submissions correctly executes the one or more test cases;
identifying which of the plurality of code submissions incorrectly executes the one or more test cases;
generating a correct control flow representation for each code submission that correctly executes the one or more test cases;
generating an incorrect control flow representation for each code submission that incorrectly executes the one or more test cases; and
comparing each of the incorrect control flow representations to one or more of the correct control flow representations to determine one or more corrections to be made to a corresponding code submission that incorrectly executed the one or more test cases.

11. The system of claim 10, further comprising instructions for providing the one or more corrections to an individual who submitted the corresponding code submission that incorrectly executed the one or more test cases.

12. The system of claim 10, wherein the correct control flow representations are arranged in a hierarchical manner.

13. The system of claim 10, wherein the correct control flow representations are arranged in a cluster of similar correct control flow representations.

14. The system of claim 13, wherein comparing each of the incorrect control flow representations to one or more of the correct control flow representations comprises determining which cluster includes correct control flow representations that match each of the incorrect control flow representations.

15. The system of claim 14, further comprising instructions for determining which of the one or more correct control flow representations in the cluster has a code submission that corresponds to a code submission associated with the incorrect control flow representation.

16. The system of claim 15, further comprising instructions for determining a distance metric between the code submission of each of the correct control flow representations in the cluster and the code submission associated with the incorrect control flow representation.

17. The system of claim 10, further comprising instructions for generating an abstract syntax tree for each code submission that correctly executes the one or more test cases and for each code submission that incorrectly executes the one or more test cases.

18. A computer-readable storage medium storing computer executable instructions which, when executed by a processing unit, causes the processing unit to perform a method for automatically correcting incorrect code submissions, comprising:
receiving a code submission;
testing the code submission using one or more test cases to determine whether the code submission is an incorrect code submission;
when it is determined that the code submission is an incorrect code submission:
generating an incorrect control flow representation of the incorrect code submission;
comparing the incorrect control flow representation to a cluster of correct control flow representations, wherein each correct control flow representation in the cluster is associated with a correct code submission;
identifying one or more correct control flow representations that correspond to the incorrect control flow representation;
comparing the incorrect code submission with the correct code submissions associated with each of the identified one or more correct control flow representations;
generating one or more corrections to the incorrect code submission based on the comparison between the incorrect code submission and the correct code submission; and
providing the one or more corrections to an individual that submitted the incorrect code submission.

19. The computer-readable storage medium of claim 18, further comprising instructions for generating a correct control flow representation of the code submission when it is determined, using the one or more test cases, that the code submission is a correct code submission.

20. The computer-readable storage medium of claim 19, further comprising instructions for:
storing the correct control flow representation, along with the associated code submission in a database; and
associating the correct control flow representation with other correct control flow representations that have a similar control flow.
